(19) United States
(12) Patent Application Publication
(10) Pub. No.: US 2007/0288343 A1
(43) Pub. Date: Dec. 13, 2007

(54) Direct connection trade system

(76) Inventors: Blain Reinkensmeyer, Birmingham, MI (US); Brandon Reinkensmeyer, Birmingham, MI (US)

Correspondence Address: BLISS MCGLYNN, P.C., 2075 WEST BIG BEAVER ROAD, SUITE 600, TROY, MI, 48084, US

(21) Appl. No.: 11/501,361

(22) Filed: Aug. 9, 2006

Related U.S. Application Data
(60) Provisional application No. 60/707,377, filed on Aug. 11, 2005.

(51) Int. Cl. G06Q 40/00

(52) U.S. Cl. 705/37

(57) ABSTRACT

An electronic trading system that provides a direct connection between buyers and sellers of exchangeable assets that allows real-time negotiation of the selling price without intervention from a middleman. The trading system includes a central trading hub that provides individual trading accounts, allowing users to logon through custodial server accounts, access all trading activities for any particular exchangeable asset, enter bid or ask offers, or buy or sell exchangeable assets to fill or partially fill the current bid or ask offers. The trading system provides the ability for users to execute multiple transactions concurrently. The trading system further includes a negotiating component that allows users to individually negotiate with the other users that have posted the current bid and ask offers. The trading system utilizes the results of the negotiating component to generate execution orders and routes them back to the custodial servers of the individual users to complete the trading transaction.

### CROSS-REFERENCE TO RELATED APPLICATION

The present application claims the priority date of copending U.S. Provisional Patent Application Ser. No. 60/707,377, filed Aug. 11, 2005.

### BACKGROUND OF THE INVENTION

1. Field of the Invention

The present invention relates generally to electronic trading systems and, more specifically, to an electronic trading system that provides a direct connection between buyers and sellers that allows real-time negotiation of the selling price without a middleman such as a market specialist.

2. Description of the Related Art

Generally speaking, trading or the buying and selling of various types of exchangeable assets such as securities, commodities, stocks, securities, bonds, futures, options, currencies, and other products is well known. Originally, trading occurred in the market place directly between individuals that either personally held the assets or between representatives of the asset holders. Over the years, trading has become one of the mainstays in the underpinnings of free world economics, and it continues to evolve to encompass many of the technological advances that have taken place in recent years. Presently, at least sixty exchanges throughout the world utilize electronic trading in varying degrees to trade exchangeable assets such as commodities, stocks, securities, bonds, futures, options, currencies, and other products.

Furthermore, a large number of brokerage houses and market specialists have also adopted new technologies and now provide on-line Internet and World Wide Web trading access to private investors and individuals. The ability for individuals to trade exchangeable assets online has opened securities trading and personal management of investment portfolios to a much wider cross-section of the general public. This has generally stimulated investment in the securities and commodities markets and has eliminated much of the difficulty and drudgery previously required for individual investors to continually monitor and track the movement of the markets. However, on-line investors must still rely directly on a middleman such as brokerage houses and market specialists to perform the actual transactions or to enter in any negotiations that may occur to resolve the gaps between bid and asking prices. Additionally, during on-line based transactions, the broker or specialist and not the investor, is the one aware of all the current offerings for share or interests of a particular exchangeable asset. In this manner, the investor, whether a buyer or a seller, must wait for information to filter through the broker. Furthermore, the bid and ask offers are often not available for other investors to view so that those who are not currently seeking to buy or sell, but might be prompted to enter into the process, are unaware of any ongoing negotiations.

Therefore, it is desirable to provide a system and method that allows the on-line transferring of exchangeable assets without a middleman such as a broker or market specialist. It is also desirable to provide an on-line system and method that has the ability for multiple users to view the orders, thereby making any online order widely available. It is further desirable to provide an on-line system and method that allows users the ability to fill their own orders with or without the help of a middleman such as a market maker or specialist in such a way as to allow direct live negotiations through an Internet connection.

### SUMMARY OF THE INVENTION

Accordingly, the present invention is an electronic trading system and method that provides a direct connection between buyers and sellers of exchangeable assets, which allows real-time negotiation of the selling price without intervention from a middleman. The electronic trading system and method includes a central trading hub that provides individual trading accounts, allowing users to logon through custodial server accounts, access all trading activities for any particular security, enter bid or ask offers, or buy or sell exchangeable assets to fill or partially fill the current bid or ask offers. The electronic trading system and method has the ability for users to execute multiple transactions concurrently. The electronic trading system and method further includes a negotiating component that allows users to individually negotiate with the other users that have posted the current bid and ask offers. The electronic trading system and method utilizes the results of the negotiating component to generate execution orders and routes them back to the custodial servers of the individual users to complete the trading transaction.

One advantage of the present invention is that a direct connection trading system and method is provided that overcomes the disadvantages of the current online trading systems and methods by allowing users to see all the bid and ask orders available for an exchangeable asset at one time and allows users to be directly connected to each other. Another advantage of the present invention is that the direct connection trading system allows users to directly negotiate the price of an order, and then directly exchange the assets without the intervention of a middleman such as a brokerage house or market specialist. Yet another advantage of the present invention is that the direct connection trading system allows all orders available at the time to be seen by everyone and be filled by numerous users simultaneously regardless of the bid or ask price.

Other features and advantages of the present invention will be readily appreciated, as the same becomes better understood after reading the subsequent description taken in connection with the accompanying drawings.

### BRIEF DESCRIPTION OF THE DRAWINGS

FIG. 1 is a diagrammatic view of a direct connection trading system, according to the present invention.

FIG. 2 is a flowchart of a method, according to the present invention, using the direct connection trading system of FIG. 1.

FIG. 3 is a graphic representation of a trading screen of the direct connection trading system of FIG. 1 for presenting trading information to a user.

FIG. 4 is a graphic representation of a negotiating screen of the direct connection trading system of FIG. 1 for presenting negotiating capability and information to a user.

### DESCRIPTION OF THE PREFERRED EMBODIMENT(S)

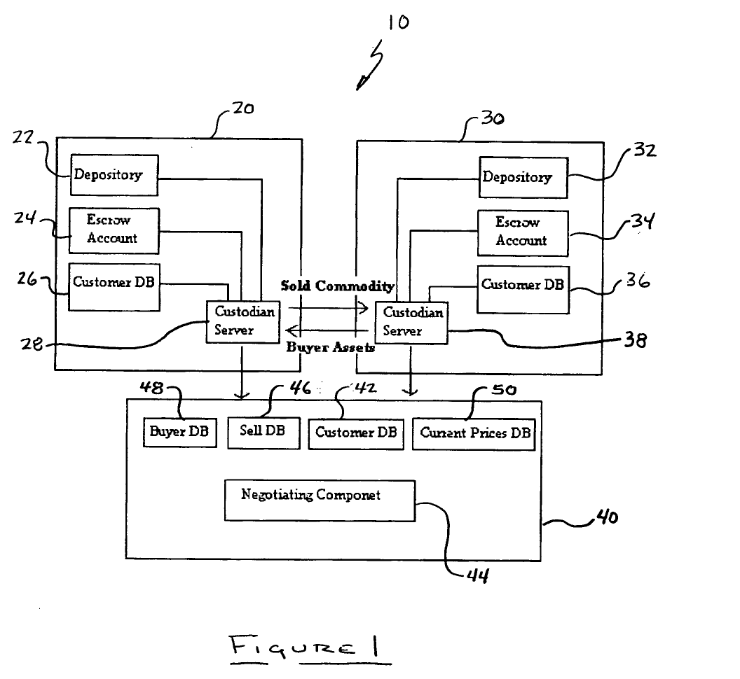

Referring to the drawings and, in particular FIG. 1, one embodiment of a direct connection trading system 10, according to the present invention, is schematically illustrated and generally shown. In the present invention, a user initially utilizes an online Internet brokerage house or market specialist website such as Ameritrade, Etrade, Scottrade, for example, to establish a user account and maintain a fund depository that will be necessary to execute trading transactions. As illustrated in FIG. 1, the system 10 includes blocks 20 and 30, which represent two separate user accounts. As previously stated, user accounts 20 and 30 may be established at any one of the wide variety of online trading services. Each user account 20 and 30 has a fund depository 22, 32, an escrow account 24, 34, a stored user database (Customer DB) 26, 36, and operates through the server system of the trading service (Custodian Server) 28, 38, respectively. It should be appreciated that, in this discussion, the term “exchangeable asset” may be a “security” “stock”, “option”, “currency”, and/or “commodity” and that these exchangeable assets may be used interchangeably in the context of the system and method of the present invention.

The system 10 also includes a central trading hub 40. To place an order or offer, for example, shares for trade, the user transfers to the central trading hub 40 through the respective user accounts 20, 30 of the online trading service. The central trading hub 40 is a separate online entity that allows all users logged into the central trading hub 40 to view the open orders and offers. The central trading hub 40 maintains separate user accounting information as indicated by the customer database (Customer DB) 42. The central trading hub 40 also includes a negotiating component 44. When a user logs onto the central trading hub 40 and makes a decision to buy or sell, the central trading hub 40 moves the users information into a separate database specific to either the decision to buy or sell. Specifically, if a user decides to offer shares for sale (ask), his/her information is placed in the seller database (Sell DB) 46. If a user decides to buy (bid) on shares offered for sale, his/her information is placed in the buyer database (Buyer DB) 48. The central trading hub 40 also takes the various sell and buy (ask/bid) information and stores it in a pricing database (Current Price DB) 50. The pricing database 50 is available for all users logged into the central trading hub 40 to view. In this manner, all users logged into the central trading hub 40 and viewing the information a particular stock can see the current ask and bid information of the sellers and buyers.

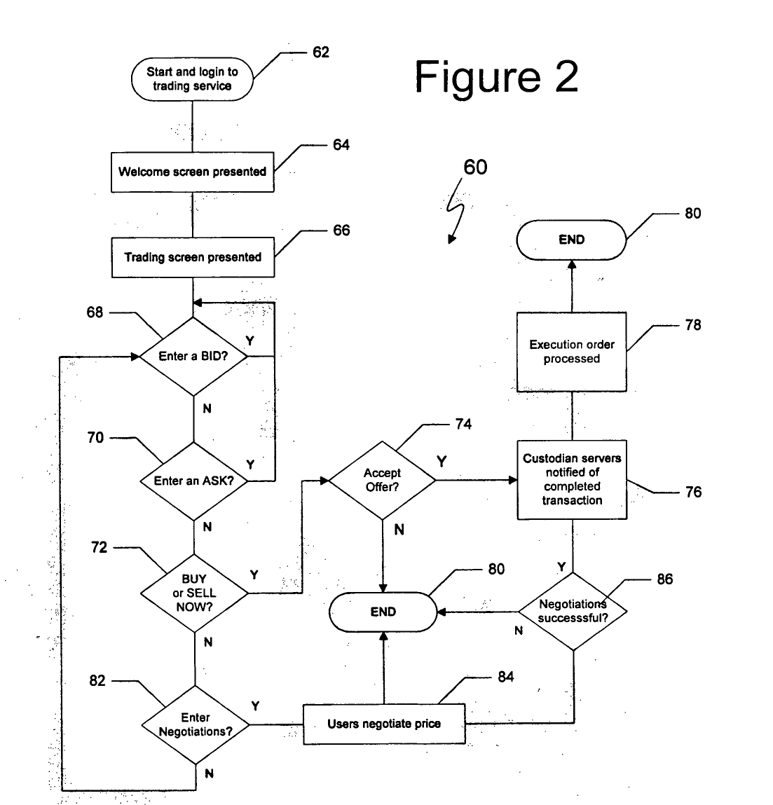

Referring now to FIG. 2, a flowchart of a method, according to the present invention, is generally shown at 60. FIG. 2 in particular illustrates the separate steps available to online inventors through the central trading hub 40. In step 62, the user signs into the central trading hub 40 through his/her online trading service account. The user is provided with a welcome screen in step 64 that provides the user with the opportunity to select the particular stock of choice. When the user chooses a particular stock, he/she is presented with a trading screen in step 66 that presents the ongoing activities for that stock. The user may then decide to place a bid (offer to buy a number of shares at a particular price) at step 68, decide to present shares at an asking price (offer to sell a number of shares at a particular price) at step 70, or merely observe the ongoing activities as they proceed.

For example, a user “A” logs on to the central trading hub 40, picks stock “XYZ” to observe, and is presented with XYZ current information that indicates that XYZ is showing a bid of $10.35 per share and an ask of $10.37 per share. The presentation on the trading screen is also available to all users logged into the central trading hub 40 that request information on XYZ stock. In this example, user “A” owns 1,000 shares of XYZ stock. On the trading screen, user “A” sees an order of 1,000 shares at the bid price of $10.35 presented by another user and decides to sell all 1,000 shares at that price to that user (buyer). In the direct connection trading method of the present invention, user “A” is able to sell the 1,000 shares of XYZ directly to the user who has presented the $10.35 bid price by deciding in step 72 to execute the “Buy Now” or “Sell Now” option to be discussed. It should be appreciated that, in this trade transaction, the method allows for the two users to connect to one another without the interference or intervention of a middleman such as a brokerage house or market specialist.

In most circumstances, an immediate buy or sell is not the normal course of business and the users of the present invention are likely to desire to negotiate the best possible exchange value for themselves. In this case, any individual user that has presented a bid offer, has presented an ask offer, or is observing the stock activity may desire to enter negotiations regarding the current bid and ask presentations.

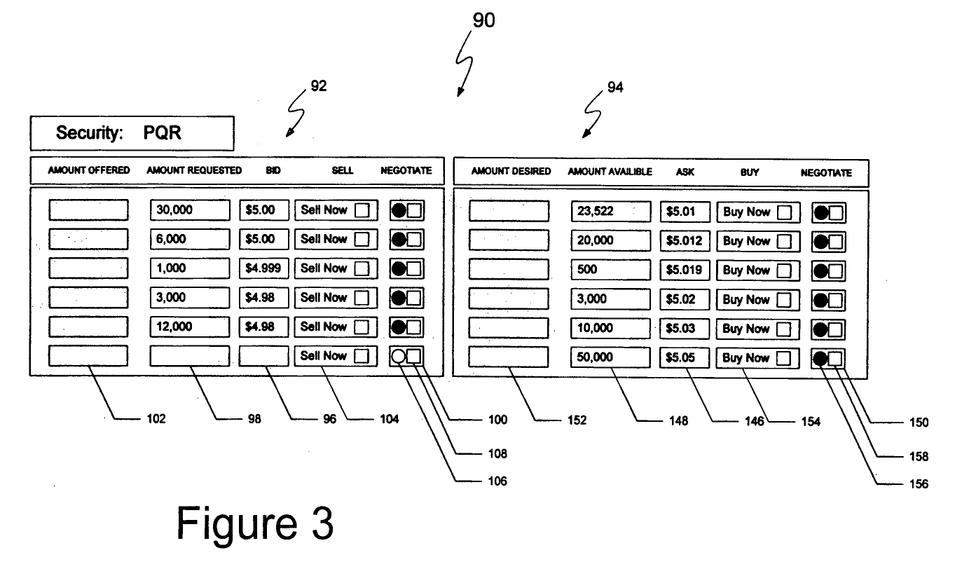

Referring to FIG. 3, an example of how the method and system of the present invention may be graphically presented to a user is illustrated. As illustrated in FIG. 3, one embodiment of how the bid and ask information may by presented in a trading screen 90 (step 66 of FIG. 2) is shown. The presentation shown in the trading screen 90 in FIG. 3 is a graphic presentation of the current pricing information about stock “PQR” and is available to all users logged into the central trading hub 40 that request information on stock “PQR”.

The trading screen 90 provides the “bid” data block, generally indicated at 92, and the “ask” data block, generally indicated at 94. The bid data block 92 provides the current bid offers presented by various (undisclosed) buyers on each row as indicated by the bid price the buyer is willing to pay in the “BID” column 96 and the amount of shares desired in the “AMOUNT REQUESTED” column 98. In this case, five bids have been placed for PQR shares. Additionally, the bidders, when submitting a bid, have the ability to indicate that they are willing to negotiate on the price of the shares. In this example of the trading screen 90, the individual bidder's willingness to negotiate is shown by a green light illuminating the indicator light in the “NEGOTIATE” column 100. Likewise, a red light in column 100 presents a non-negotiable bid.

A few possible scenarios may arise in the situation. First, an owner of PQR stock viewing this information can find a bid acceptable as entered and agree to sell shares to the bidder by entering a number of shares to sell in the “AMOUNT OFFERED” column 102 and selecting the “SELL NOW” block in the “SELL” column 104. This triggers step 72 of FIG. 2, which moves the process to decision block 74 that allows the offer to be accepted or rejected. If accepted, in this case by the bidder, in step 76 of FIG. 2, the transaction information in the central trading hub 40 is passed back to the custodian servers 28 and 38 of the trading service of the buyer and seller users (FIG. 1), the details of the transaction are finalized, and the execution order is performed in the normal manner in step 78. Additionally, the trading screen 90 is updated to reflect the transaction. Even if the “SELL NOW” block is selected by the seller, the bidder (buyer) has the option in decision block 74 not to accept the offer. This may occur because the seller does not have all of the shares in the bidders “AMOUNT REQUESTED” or the bidder (buyer) simply refuses the sell offer. If the bidder refuses to accept the offer, the “No” path from decision block 86 is taken to the “END” block 80. It should be appreciated, however, that users may partially fill the bid or ask from one user and complete the remainder of the desired transaction from another user. Additionally, due to the manner in which the trading screen 80 is designed multiple transactions can occur at the same time.

Referring again to FIG. 3, if the bidder has indicated that his/her bid offer is negotiable with a green color in the negotiation indicator 106 in the “NEGOTIATE” column 100, then the seller has the option to select the action button 108 next to the negotiation indicator 106 and request direct negotiation with the bidder. This moves the method through the “Yes” path of decision block 82 of FIG. 2 and triggers the direct user negation block in step 84. It should be appreciated that the request for direct negotiation in step 84 causes the central trading hub 40 to present the negotiation screen to the seller and the bidder.

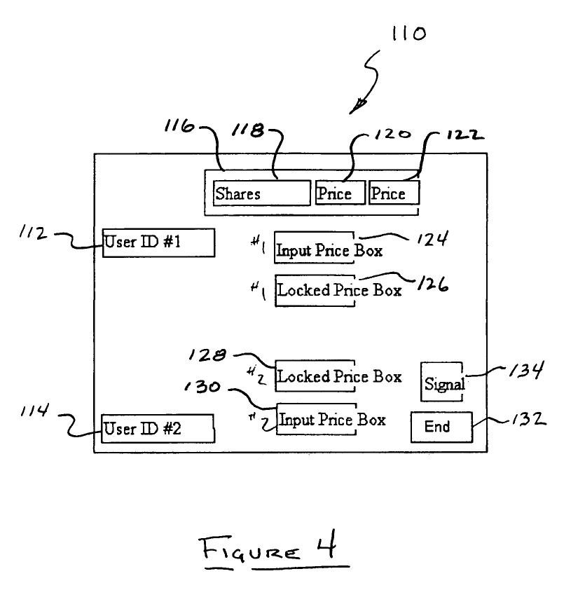

Referring to FIG. 4, one embodiment of the negotiating screen 110 of the direct connection trade system 10 is shown. The negotiating screen 110 includes user identification boxes 112 and 114, which are filled in by the central trading hub 40 with the bidder and seller identification numbers. A transaction block 116 at the top provides a reiteration of the current transaction by showing the number of shares offered by the seller in the shares box 118, the current bid price in box 120, and the lowest current ask price (if available) for reference, in box 122. In the current example, user #1 in identification box is the bidder and user # 2 is the seller. When the negotiation screen opens, the #1 input price box 124, the #1 locked price box 126, the #2 locked price box 128, and the #2 input price box 130 are empty. The seller, in a negotiation to the bidder's $5.00 a share price, for example, enters a first counteroffer sales price, such as $5.008 per share in the #2 input price box 130. When the seller is satisfied with this first counteroffer, it is moved to the #2 locked price box 128 and is then viewable by the bidder.

The bidder may respond to the counteroffer in one of three ways. The bidder may find the counteroffer unacceptable and end all negotiations by selecting the end button 132. In this case, the negotiations have been unsuccessful and the “No” path of decision block 86 is taken to the “END” block 80. The bidder may alternately accept the counteroffer number by placing the same number in the #1 input price box 124. If the seller's counteroffer has been accepted, because the bidder's number in the #1 locked price box 126 is the same as the number in the #2 locked price box 128, then the negotiation has ended as an agreement has been reached. In this case, the end button 132 will be unavailable as the negotiations have reached a successful conclusion. When this occurs, the “Yes” path of the “Negations Successful?” decision block 86 in FIG. 2 is satisfied and the method moves to completion through blocks 76 and 78 as previously described. Additionally, the bidder may choose to enter a second counter offer such as $5.002 per share, for example, in the #1 input price box 124. The bidder's number will then be automatically moved to the #1 locked price box 126 and be visibly presented to the seller. The seller then has the same options as the bidder did previously and may unsuccessfully end the negotiations, may counteroffer, or may reenter the bidder's counteroffer as acceptance. It should be appreciated that the system 10 may include a timer that counts down and keeps the counteroffer steps within particular time limits and automatically ends the negotiation without resolution if the time limits elapse. It should also be appreciated that the negotiation process may continue as long as the participating users are actively negotiating and there is a price difference between the counteroffers.

A signal light 134 is also provided on the negotiation screen 110. The signal light may be used in any number of ways. For example, the signal light 136 may indicate when the negations have become successful and the process is complete, and the signal light may change color, for example, as the timer for a counteroffer time limit is running out.

Referring again to FIG. 3, the trading screen 90 also provides the “ask” data block 94. The ask data block 94 provides the current asking price offers presented by various (undisclosed) sellers on each row as indicated by the ask price the seller is willing to sell his/her shares for in the “ASK” column 146 and the amount of shares offer for sale in the “AMOUNT AVAILABLE” column 148. In this case, five offers for sale (asks) have been placed for PQR shares. Additionally, the sellers, when submitting an “ask”, have the ability to indicate that they are willing to negotiate on the price of the shares. In the example illustrated in the trading screen 90, the individual seller's willingness to negotiate is shown by a green light in the “NEGOTIATE” column 150. Likewise, a red light in column 150 presents a non-negotiable bid.

A few possible scenarios may arise in this situation. First, a user desiring to buy PQR stock and viewing this information can find an ask acceptable as entered and agree to buy shares from the seller by entering the number of shares desired in the “AMOUNT DESIRED” column 152 and selecting the “BUY NOW” block in the “BUY” column 154. This triggers step 72 of FIG. 2, which moves the process to decision block 74 and allows the offer to be accepted or rejected. If accepted, in this case by the seller, in step 76 of FIG. 2, the transaction information in the central trading hub 40 is passed back to the custodian servers 28 and 38 of the trading service of the buyer and seller users (FIG. 1). The details of the transaction are finalized and the execution order is performed in the normal manner in step 78. Additionally, the trading screen 90 is updated to reflect the transaction. Even if the “BUY NOW” block is selected by the buyer, the seller has the option in decision block 74 not to accept the offer. This may occur because the buyer has not requested enough of the seller's shares listed in the seller's “AMOUNT AVAILIBLE” or the seller simply refuses to complete the transaction. If the seller refuses to accept the offer, the “No” path from decision block 86 is taken to the “END” block 80.

Referring again to FIG. 4, if the seller has indicated that his/her ask offer is negotiable with a green color in the negotiation indicator 156 in the “NEGOTIATE” column 150, then the buyer has the option to select the action button 158 next to the negotiation indicator 156 and request direct negotiation with the seller. This moves the method through the “Yes” path of decision block 82 of FIG. 2 and triggers the direct user negotiation block in step 84. The request for direct negotiation in step 84 causes the central trading hub 40 to present a negotiation screen 110 to the seller and the buyer.

Referring to FIG. 4, the negotiating screen of the present invention is shown. The negotiating screen 110 includes user identification boxes 112 and 114, which are filled in by the central trading hub 40 with the bidder and seller identification numbers. A transaction block 116 at the top provides a reiteration of the current transaction by showing the number of shares desired by the buyer in the shares box 118, the current ask price in box 120, and the lowest current bid price (if available) for reference, in box 122. In the current example, user #1 in identification box is the seller and user # 2 is the bidder (buyer). When the negotiation screen opens, the #1 input price box 124, the #1 locked price box 126, the #2 locked price box 128, and the #2 input price box 130 are empty. The buyer, in a negotiation to the seller's $5.01 a share price, for example, enters a first counteroffer sales price, such as $5.002 per share in the #2 input price box 130. When the buyer is satisfied with this first counteroffer, it is moved to the #2 locked price box 128 and is then viewable by the seller.

The seller may respond to the counteroffer in one of three ways. The seller may find the counteroffer unacceptable and end all negotiations by selecting the end button 132. In this case, the negotiations have been unsuccessful and the “No” path of decision block 86 is taken to the “END” block 80. The seller may alternately accept the counteroffer number by placing the same number in the #1 input price box 124. If the buyer's counteroffer has been accepted, because the seller's number in the #1 locked price box 126 is the same as the number in the #2 locked price box 128, then the negotiation ends as an agreement has been reached. In this case, the end button 132 will be unavailable, as the negotiations have reached a successful conclusion. When this occurs, the “Yes” path of the “negations successful?” decision block 86 in FIG. 2 is satisfied and the method moves to completion through blocks 76 and 78 as described above. Additionally, the seller may choose to enter a second counter offer such as $5.008 per share, for example, in the #1 input price box 124. The seller's number will then be automatically moved to the #1 locked price box 126 and be visibly presented to the seller. The buyer then has the same options as the bidder did previously and may unsuccessfully end the negotiations, may counteroffer, or may reenter the seller's counteroffer as acceptance.

Accordingly, the present invention overcomes the disadvantages of the current online trading systems and methods by providing a direct connection between buyers and sellers of exchangeable assets, which allows real-time negotiation of the selling price without intervention from a middleman. The trading system 10 of the present invention has the advantage of a central trading hub 40 that provides individual trading accounts, allowing users to logon through custodial server accounts, access all trading activities for any particular exchangeable asset, enter bid or ask offers, or buy or sell exchangeable assets to fill or partially fill the current bid or ask offers. Thus, the trading system 10 provides the ability for users to execute multiple transactions concurrently. The trading system 10 includes a negotiating component that allows users to individually negotiate with the other users that have posted the current bid and ask offers. Additionally, the trading system 10 utilizes the results of the negotiating component to generate execution orders and routes them back to the custodial servers of the individual users to complete the trading transaction.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. An electronic trading system comprising:
a plurality of custodial servers;
a central trading hub communicating with the custodial servers and providing individual trading accounts, allowing users to logon through custodial server accounts, accessing all trading activities for any particular exchangeable asset, entering bid or ask offers, or buying or selling exchangeable assets to fill or partially fill the current bid or ask offers; and
a negotiating component that allows users to individually negotiate with the other users that have posted the current bid and ask offers, wherein the results of the negotiating component generates execution orders and routes them back to the custodial servers of the individual users to complete the trading transaction.

2. An electronic trading system as set forth in claim 1 including a plurality of user accounts communicating with said custodial servers.

3. An electronic trading system as set forth in claim 2 wherein each of said user accounts includes a fund depository, an escrow account, and a stored user database.

4. An electronic trading system as set forth in claim 2 wherein each of said user accounts includes an escrow account.

5. An electronic trading system as set forth in claim 2 wherein each of said user accounts includes a stored user database.

6. An electronic trading system as set forth in claim 1 wherein said central trading hub includes a customer database.

7. An electronic trading system as set forth in claim 1 wherein said central trading hub includes a pricing database.

8. An electronic trading system as set forth in claim 1 wherein said central trading hub includes a seller database.

9. An electronic trading system as set forth in claim 1 wherein said central trading hub includes a buyer database.

10. A method of electronic trading, said method comprising the steps of:
providing a plurality of custodial servers;
providing a central trading hub that communicates with the custodial servers;
providing individual trading accounts;
allowing users to logon through custodial server accounts with the custodial servers;
accessing all trading activities for any particular exchangeable asset by the users;
entering bid or ask offers, or buying or selling exchangeable assets by the users to fill or partially fill the current bid or ask offers; and
allowing users to individually negotiate with the other users that have posted the current bid and ask offers, wherein the results of the negotiating component generates execution orders and routes them back to the custodial servers of the individual users to complete the trading transaction.

11. A method as set forth in claim 10 including the step of signing into the central trading hub by the users through the users' online trading service accounts.

12. A method as set forth in claim 10 including the step of providing the user the opportunity to select a particular exchangeable asset.

13. A method as set forth in claim 10 including the step of presenting a trading screen to the user that presents ongoing activities for the particular exchangeable asset.

14. A method as set forth in claim 10 including the step of entering a bid by the user for the particular exchangeable asset.

15. A method as set forth in claim 14 including the step of entering an asking price by the user for the particular exchangeable asset.

16. A method as set forth in claim 15 including the step of deciding to execute a buy now or sell now option by the user for the particular asset.

17. A method as set forth in claim 10 including the step of entering negotiations for the particular exchangeable asset.

18. A method as set forth in claim 17 including the step of users negotiating the price for the particular exchangeable asset.

19. A method as set forth in claim 18 including the step of determining whether the negotiations were successful.

20. A method as set forth in claim 19 including the step of notifying custodian servers of completed transaction.

21. A method as set forth in claim 20 including the step of processing an execution order for the completed transaction.
